(19) United States
(12) Patent Application Publication
(10) Pub. No.: US 2025/0066941 A1
(43) Pub. Date: Feb. 27, 2025

(54) ADDITIVE MANUFACTURING OF METAL OBJECTS VIA ELECTRODEPOSITION

(71) Applicant: NEXA3D, INC., Ventura, CA (US)

(72) Inventors: William Jack MACNEISH, III, Santa Ana, CA (US); Nirup NAGABANDI, Pflugerville, TX (US); Garrett JONES, Newport Beach, CA (US); Pavan NARSAI, Fountain Valley, CA (US)

(21) Appl. No.: 18/729,449

(22) PCT Filed: Jan. 18, 2023
(86) PCT No.: PCT/US2023/060831

§ 371 Date: Jul. 16, 2024

Related U.S. Application Data
(60) Provisional application No. 63/301,044, filed on Jan. 19, 2022.

(51) Int. Cl. C25D 1/00; B33Y 30/00

(52) U.S. Cl. CPC C25D 1/003; B33Y 30/00

(57) ABSTRACT

A three-dimensional printer, system, and method for electrodeposition. The three-dimensional printer and system include a deposition anode, a build plate, wherein at least one of the deposition anode and build plate are moveable relative to the other in at least two axes, and a power supply electrically connected to the deposition anode and the build plate. The method includes forming ions of a feedstock in an electrolyte solution, providing an E-field, and transporting the ions in an E-field to a build plate to form a three-dimensional component.

### RELATED APPLICATIONS

This application is a National Stage under 35 USC 371 of and claims priority to International Application No. PCT/US2023/060831, filed 18 Jan. 2023, which claims the priority benefit of U.S. Application No. 63/301,044, filed 19 Jan. 2022.

### FIELD

The present disclosure is directed to a machine, process, and materials for the additive manufacturing of metal objects via three-dimensional electrodeposition.

### BACKGROUND

Additive manufacturing (AM) describes manufacturing processes where three-dimensional parts are formed layer by layer. Examples of additive manufacturing processes include fused filament fabrication and selective laser sintering. Additive manufacturing (AM) provides design freedom allowing designers and manufacturers to form complex and organic shapes that are generally not easily produced by more traditional processes. AM not only allows production of specialized components in small quantities, but it also makes possible the creation of devices and materials that may be difficult to produce by traditional means. However, this does not apply to all technologies and often; each technology has a trade off in through-put, resolution, material purity, and part complexity.

Existing metal additive manufacturing technologies depend on powder and wire feedstock; and then employ direct energy, sintering, binder jetting and other processes in various fashions to achieve additive manufacturing. In these technologies, it can be relatively hard to control metal purity as each process involves either foreign material (binder, etc.), complex feedstock (powder), or non-inert atmospheres and may result in lower metal purity. Another technology, electrodeposition, offers a solution for metal deposition of relatively increased purity and a pathway to create sub-micron resolution and ability to create most complex geometries. However, masking is required to form geometries from the electrodeposited material and may limit the height and definition of the electroplated material.

Thus, currently existing technologies generally exhibit a trade-off between resolution and throughput, and often fail to guarantee the composition of the part. With the electrodeposition approach, resolution and throughput are highly changeable with ability to achieve sub-micron resolution. Due to the nature of the deposition, part composition is relatively predictable for either pure metals or alloys.

While the present processes and manufacturing systems achieve their goals, room remains for development in the field of additive manufacturing particularly with regard to metal deposition.

### SUMMARY

According to various aspects, the present disclosure relates to a three-dimensional printer for electrodeposition. The three dimensional printer includes a deposition anode, a build plate, wherein at least one of the deposition anode and build plate are moveable relative to the other in at least two axes, and a power supply electrically connected to the deposition anode and the build plate. In aspects, the deposition anode is in a deposition tube.

According to additional aspects, the present disclosure relates to a method for three-dimensionally printing by electrodeposition. The method includes forming ions of a feedstock in an electrolyte solution, providing an E-field, and transporting those ions in an E-field to a build plate to form a three-dimensional component. In further aspects, a radiative energy provided by an emitting source is focused on the build plate and is moved in a first and second axis to provide spatially selective deposition.

According to yet additional aspects, the present disclosure relates to a system for electrodeposition. The system includes a deposition anode, a build plate, an electrolyte solution present between the deposition anode and the build plate, a power supply electrically connected to the deposition anode and the build plate, and a controller configured to execute instructions to apply power to the deposition anode and to the build plate, and to move at least one of the deposition anode and build plate relative to the other in at least two axes.

### DETAILED DESCRIPTION

The present disclosure is directed to a machine, process, and materials for the additive manufacturing of three-dimensional, metal objects via three-dimensional electrodeposition. Generally, feedstock is used to provide a sacrificial anode, in rod or wire form. The feed stock is passed through a deposition tube included in a print head. The print head is mounted to an X, Y, Z motion system. A deposition tube is immersed in an electroplating solution where a build plate (cathode) is positioned. The feedstock is fed to the print head using a wire fed mechanism contained in the print head as the feedstock anode is consumed; while the X, Y, Z motion system navigates the deposition tube to the required position in space relative to the build plate.

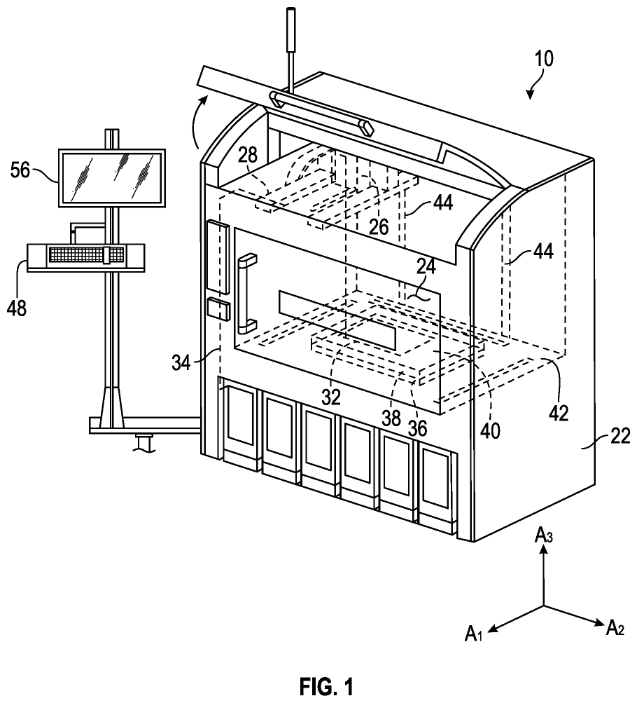

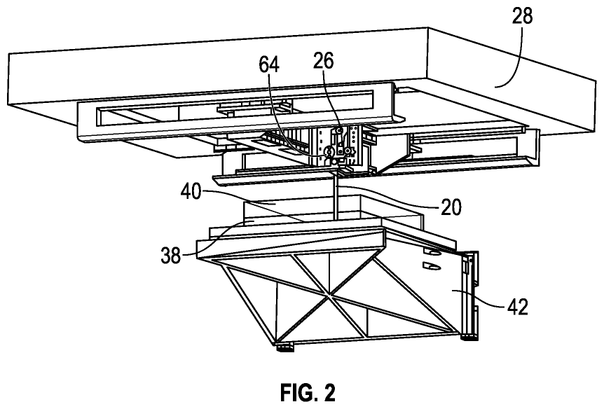

FIGS. 1 and 2 illustrate an aspect of a 3D printer 10 for electrodeposition of metals and other materials. The 3D printer 10 includes a housing 22 that encloses a build chamber 24. Within the build chamber 24 is positioned a print head 26, which is mounted on a first gantry 28 allowing independent movement of the print head 26 in one or more planes defined by a first axis A1, second axis A2, and a third axis A3. These axes are often referred to as the X, Y, and Z axes, respectfully. The first gantry 28, in aspects, may be replaced by a robotic arm movable in multiple axis, including up to five axes. The print head 26 includes a deposition tube 30 that deposits traces 32 of the feedstock 34 in successive layers on the build plate 36 to form a three-dimensional component. The build plate 36 is immersed in an electrolyte solution 38 that is contained in a vessel 40. The vessel 40 is positioned on a mounting tray 42. In the illustrated aspect, the mounting tray 42 is raised and lowered in the third axis relative to the mounting tray 42 via a third gantry 44 relative to the print head 26 or, alternatively, the print head 26 is raised and lowered in the third axis relative to the mounting tray 42 via a third gantry 44.

The feedstock 34 and build plate 36 are electrically connected to a power supply 48, which supplies power to the feedstock 34 and the build plate 36. In aspects, the feedstock 34 provides a sacrificial, deposition anode and the build plate 36 provides a cathode. In alternative aspects, the deposition anode used to form the three-dimensional component is a non-sacrificial anode 150 and a secondary or tertiary sacrificial anode of the feedstock 34 is provided. It should therefore be appreciated that the deposition anode is the anode used to form the traces 32 that form the three dimensional component one the build plate 36.

The movement of the print head 26, feed rate of the feedstock 34, movement of the mounting tray 42, power supply 48, and other features are controlled using controller 50. The controller 50 includes one or more processors 52 to execute instructions stored in one or more memory devices 54 located within the controller 50 or in another device coupled to the controller 50. In aspects other data, such as look-up tables, are also stored in the one or more memory devices 54. The controller 50 further includes input and output modules 56. Input modules include, for example, keyboards, trackpad, mice, USB ports, SD card ports, radio frequency receivers, etc. Examples of output modules include display screens, USB ports, SD card ports, radio frequency transmitters, etc.

The feedstock 34 is fed from one or more spools 60. In aspects, tension on the feedstock 34 may be regulated by a buffer system 62. While the spools 60 are illustrated as being located underneath the machine and the print head 26 it should be appreciated that a spool 60 feedstock 34 may be located above the print head 26.

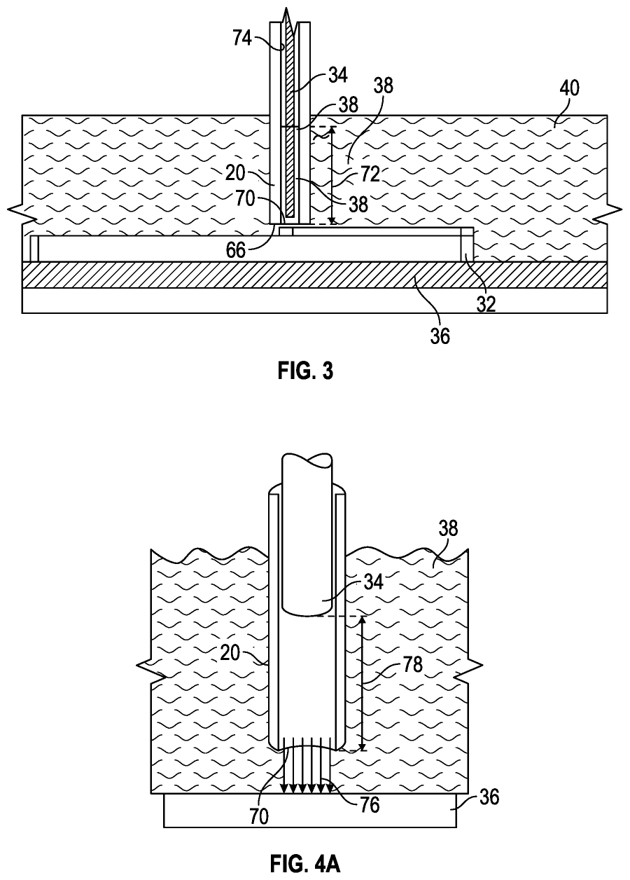

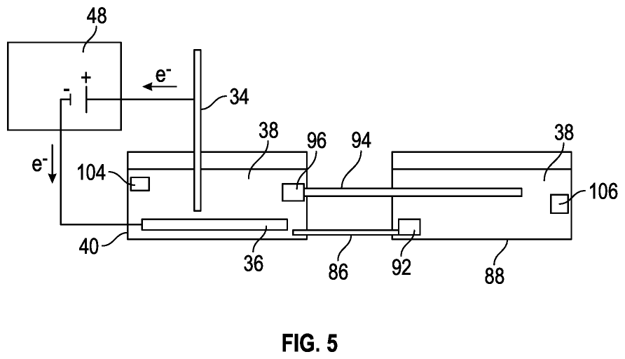

With reference to FIGS. 2 and 3, the print head 26 includes a wire feed mechanism 64. The wire feed mechanism 64 feeds the feedstock 34 through the deposition tube 20. Although, in some aspects, the deposition tube 20 may be eliminated altogether, such as illustrated in FIG. 5 described further herein; the deposition tube 20 limits the electrical field (E-field) 76 developed between the anode, feedstock 34 or non-sacrificial anode 150, and the build plate 36.

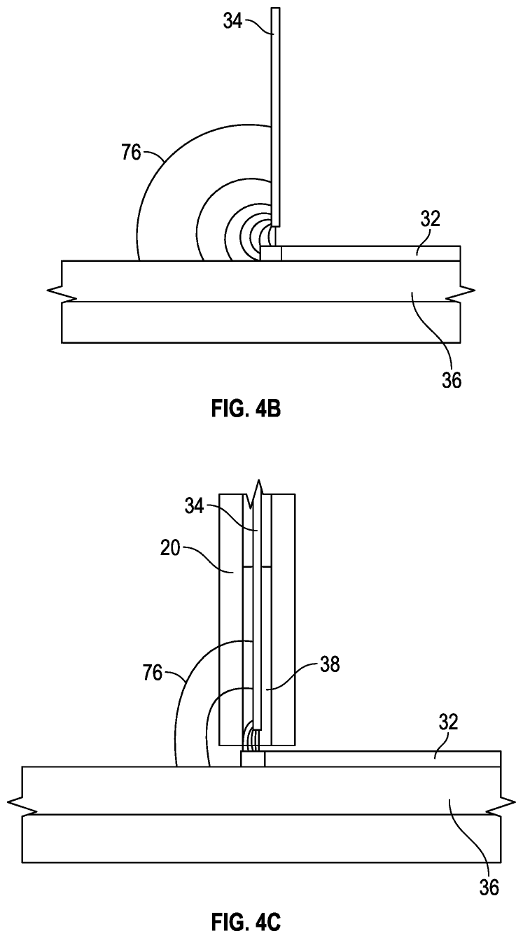

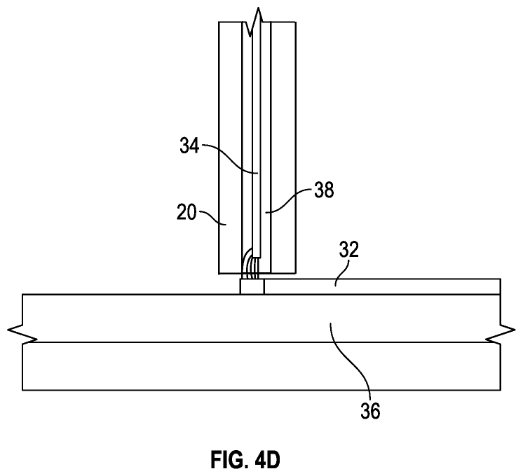

The deposition tube 20 is positioned above the build plate 36. A gap 66 is provided between the deposition tube 20 and the build plate 36. The electrolyte solution 38 positioned in the vessel 40 surrounding the tube exit 70. In the illustrated aspect, the electrolyte solution 38 enters the deposition tube 20 through the tube exit 70. However, different configurations of how the electrolyte solution 38 is contacted with the feedstock 34 and the build plate 36 are described herein. In aspects, the height 72 of the electrolyte solution 38 within the tube 20 may be adjusted such as by adding or removing gas (air) pressure within the tube or providing a seal within the tube 20 between the feedstock 34 and the inner wall of the tube 20 to stop the rise of the electrolyte solution 38 within the deposition tube 20. With reference to FIG. 4A, the feedstock 34 is retracted or spaced from the tube exit 70 by a height 78, which may be altered to adjust the resultant deposition and size of the E-fields 76 developed between the feedstock 34, or sacrificial anode 150 (discuss further hear-in), and the build plate 36. In some aspects, the closer the feedstock 34 to the tube exit 70, the more dispersed and thicker the deposited trace 32 and the further the feedstock 34 to the tube exit 70, the more focused and narrow the deposited trace 32.

With reference to FIGS. 4A through 4D, the E-field 76 is understood as a vector with a magnitude and direction. Magnitude drives the amount of deposition and direction drives spatial selectivity of the deposition. With the deposition tube 20, the E-field 76 is placed in the field direction relatively better than without the deposition tube 20 and the E-field 76 can be placed in required spatial locations as illustrated in FIGS. 4A, 4C and 4D. Without the deposition tube 20, as illustrated in FIG. 4B, the E-field 76 is more dispersed and is diffused over a relatively larger area.

Further, the E-field magnitude is, in aspects, quantified with field density and defined as charge per unit area. With the deposition tube 20, the area the charges experience is reduced, and are relatively more focused, and the E-fields' magnitude is controlled as well. In particular aspects, the purpose of the deposition tube 20 is to limit the E-field 76 vector to control the spatial selectivity. In such aspect, magnitude is primarily controlled by the power source and waveform applied by the power source and also the electrolyte solution 38 resistance.

In addition, the material that the deposition tube 20 is formed from affects the E-field 76. It should be appreciated that a conductive deposition tube 20, as illustrated in FIG. 4C, provides a relatively more dispersed and less focused E-field 76 than the E-field 76 that develops using a nonconductive deposition tube 20, as illustrated in FIG. 4 D.

It should be appreciated that the electrolyte solution 38 may need to be refreshed from time to time, by replacing the electrolyte in the solution 38. A reservoir 88 may be provided as illustrated in FIG. 5. An inlet flow path 86 and outlet flow path 94 join the reservoir 88 to the vessel 40 holding the electrolyte solution 38. A first pump 92 may be used to transfer refreshed electrolyte solution 38 from reservoir 88 through the inlet flow path 86 and into the vessel 40. A second pump 96 may be used to transfer depleted electrolyte solution 38 from the vessel 40, through the outlet flow path 94, to the reservoir 88 where the electrolyte solution 38 may be refreshed. Electrolytes, such as various salts, acids, bases, are incorporated into the electrolyte solution 38 in the reservoir 88 to obtain a desired concentration and pH. Further, the temperature of the electrolyte solution 38 may be adjusted using a heater, such as a resistive heater immersed in the electrolyte solution 38 in the reservoir 88.

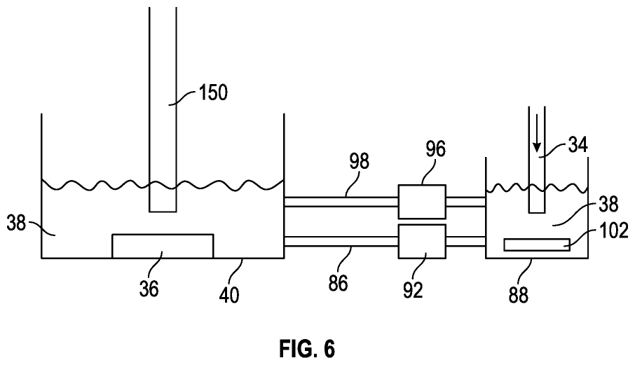

In aspects, such as illustrated in FIG. 6, a secondary anode of the feedstock 34 and a secondary cathode 102 is placed in the reservoir 88 and used as a source of ions for the electrolyte solution 38. In this aspect, the pumps 92 and 96 are placed external between the reservoir 88 and vessel 40, and in the inlet and outlet flow paths 86, 94. The pumps 92, 96 electrically isolate the electrolyte solution 38 reservoir 88 from the vessel 40. Further, in any of the above aspects, at least one of the vessel 40 and reservoir 88 include a pH meter 104, 106. A non-sacrificial deposition anode 150, in aspects made from graphite, is used to draw the ions out of the electrolyte solution 38 and deposit the traces 32 on the build plate 36. The feedstock 34, the non-sacrificial anode 150, the secondary cathode 102, and the build plate 36 are all individually electrically coupled to and powered by the power supply 48.

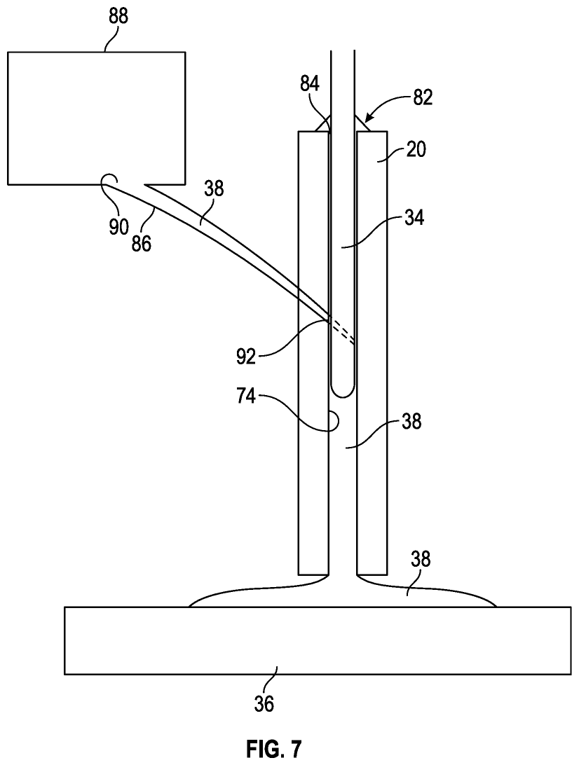

In a further configuration, such as illustrated in FIG. 7, the electrolyte solution 38 is fed through the deposition tube 20, which is moved over the build plate 36 to form the traces 32. The electrolyte solution 38 then flows down through the deposition tube 20 and onto the build plate 36. The electrolyte solution 38 covers at least a portion of the build plate 36 or flows off of the build plate 36. A seal 82 is provided between the deposition tube 20 and the feedstock 34 to prevent backflow of the electrolyte solution 38 from the entrance 84 of the deposition tube 20. It should be appreciated, that the seal 82 maybe employed in any of the aspects described herein where the electrolyte solution 38 enters the tube 20. A flow path 86, formed by, for example, tubing, connects a reservoir 88 for the electrolyte solution 38 to the deposition tube 20. The opening of the flow path 86 is connected to the reservoir 88 and the outlet of the flow path 86 is connected to the interior of the deposition tube 20. The reservoir 88 may be positioned within the printer housing 22 or external to the printer housing 22.

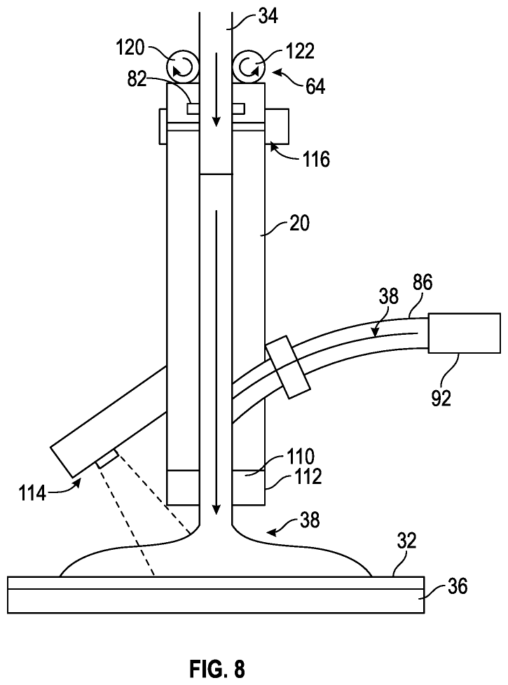

FIG. 8 illustrate various features, wherein one or more of the features may be incorporated in the various aspects described in FIGS. 1 through 7. In this aspect, a conductive ring 110 is provided at the base 112 of the deposition tube 20 and verifies contact of the solution with the build plate 36 or traces 32 being deposited on the build plate 36. Contact of the electrolyte solution 38 with the conductive ring 110 indicates that conductive solution 38 is present between the feedstock 34 and build plate 36. In aspects, the conductive ring 110 is also used for determining the concentration of electrolytes in the electrolyte solution 38. In some aspects, the deposition tube 20 is nonconductive or an insulator is placed between the conductive ring and the deposition tube 20. In additional or alternative aspects, the proximity of the deposition anode, i.e., the feedstock 34 or non-sacrificial anode 150, to the build plate 36 may be determined by monitoring changes in inductance in the power supply 48, the use of a separate inductive proximeter, or the use of a parallel circuit in the power supply 48 that monitors for shorts between the anode and cathode. In further additional or alternative aspects, a mechanical or electro-mechanical sensor located in the print head 26 may be used to determine contact of the deposition tube 20 or the deposition anode 34, 150 against the build plate 36.

Another feature illustrated in FIG. 8 is a macro camera 114. The macro camera 114 performs one or more of the following functions: verify contact of the electrolyte solution 38 and the built plate 36, either directly or through the traces 32; verify commencement of deposition of the traces 32; estimate feedstock 34 location relative to a fixed point on the build plate 36; and identifying contamination on the build plate 36. additionally, or alternatively, the macro camera 114 can be used for one or more of the following machine learning functions: determining whether solution is touching the build plate 36 in feedstock 34; features track position of feedstock 34 features; and identifying contamination.

A further feature illustrated in FIG. 8 that may be incorporated into the various embodiments is a sensor 116, such as an optical sensor, for determining the height 78 of the feedstock 34 within the deposition tube 20. In additional, or alternative aspect, sensor 116 is used to determine at the height of the deposition tube 20 relative to the build plate 36. Furthermore, the sensor 116 may be used two determine the composition of the feedstock 34 either through the reading of a barcode embedded in the feedstock 34, the detection of the feedstock 34 color, or the detection of another signifying characteristic on the feedstock 34.

Yet another additional feature illustrated in FIG. 8 that may be incorporated at any of the aspects herein is a wire feed mechanism 64 used for feeding the feedstock 34 into deposition tube 20. The wire feed mechanism 64 includes two counter-rotating hobs 120, 122. The hobs 120, 122 may include mechanical features on the periphery of one or both hobs 120, 122 for securing and applying force to the feedstock 34.

FIG. 8 also illustrates the use of a syringe pump or other controlled pump 92 positioned in an inlet flow path 86 from the reservoir 88 that introduces electrolyte solution 38 into the deposition tube 20.

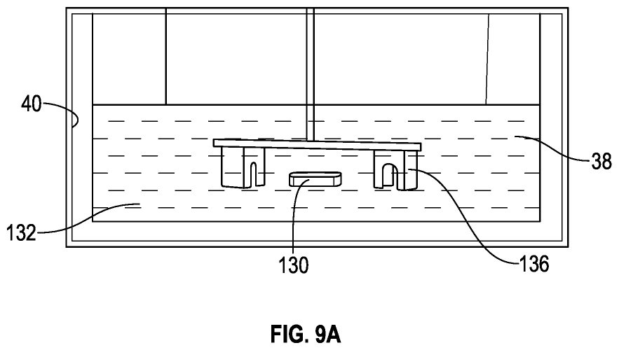

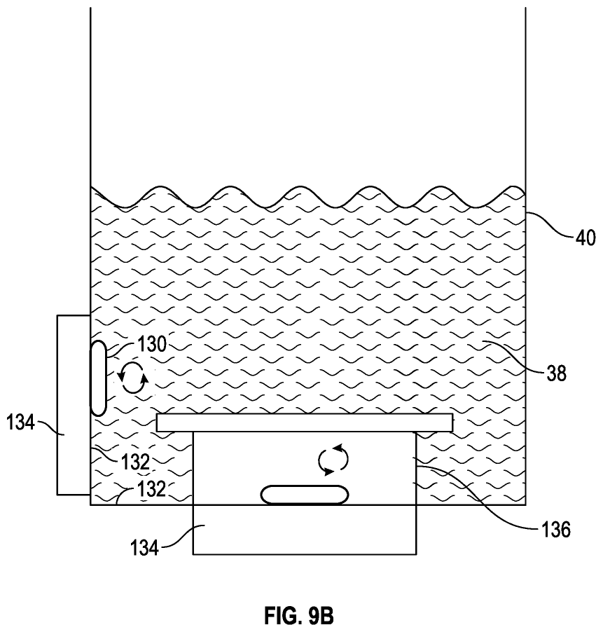

FIGS. 9A and 9B illustrate another feature, one or more magnetic stirrers 130, that may be incorporated into any of the aspects herein. The magnetic stirrers 130 may be positioned underneath the build plate 36 or anywhere else in the vessel 40 proximal to a vessel wall 132 so that it is magnetically coupled to the magnetic stirrer drive 134. When a magnetic stirrer 130 is positioned underneath the build plate 36 the build plate 36 is elevated from the vessel wall 132 by a stand 136 to provide clearance for the magnetic stirrer 130.

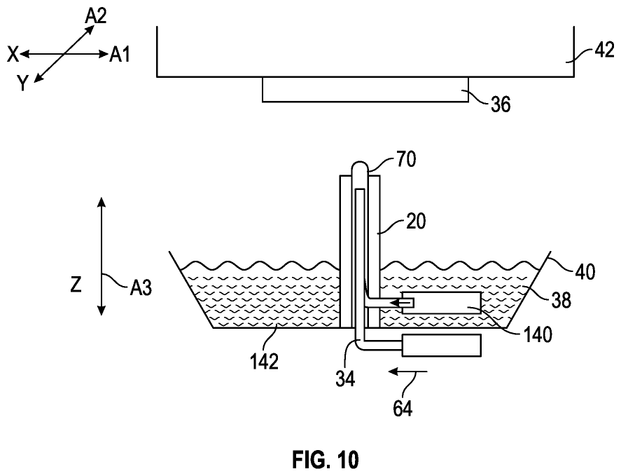

FIG. 10 illustrates an additional or alternative aspect, in which the build plate 36 is located above the feedstock 34. In this aspect, the build plate 36 is moved in the first axis A1 and in the second access A2 relative to deposition tube 20. Electrolyte solution 38 is pumped by a pump 140 from the lower region 142 of the vessel 40 into the deposition tube 20. The electrolyte solution 38 is forced above the feedstock 34 in the deposition tube 20 and flows over the deposition tube 20 back into the vessel 40. The build plate 36 and deposition tube 20 are moved in the third axis A3 sufficiently close to allow the electrolyte solution 38 to contact the build plate 36 as it exits the deposition tube 20.

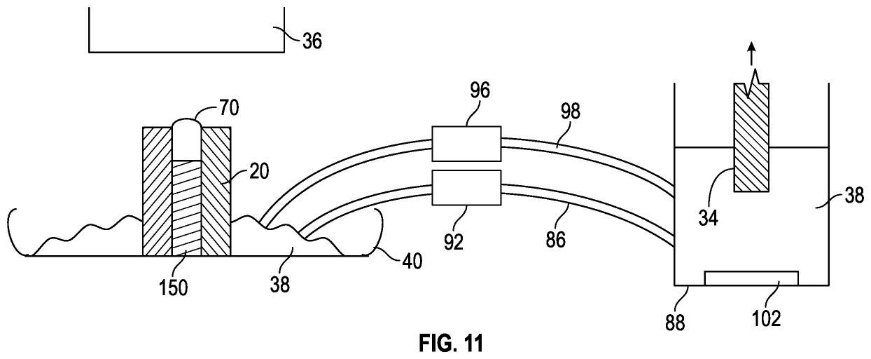

FIG. 11 illustrates an additional or alternative aspect where in the build plate 36 is placed above the deposition tube 20 and a non-sacrificial anode 150. In this aspect the build plate is moved in the first axis A1 and second axis A2 relative to the deposition tube 20. Again, electrolyte solution 38 is forced into the deposition tube 20, over the non-sacrificial anode 150 and exit 70 of the deposition tube 20. Again, in this aspect build plate 36 and deposition tube 20 are brought close enough to allow the electrolyte solution 38 to contact the build plate 36 as it exits the deposition tube 20. A feedstock 34 is provided as a sacrificial anode within the reservoir 88. A secondary cathode 102 is provided in the reservoir 88. An inlet flow path 86 And outlets flow path 98 are provided between the reservoir 88 and the vessel 40. Pumps 92, 96 are provided in the flow paths 86, 98 and electrically isolates the electrolyte solution 38 in the vessel 40 and reservoir 88. As ions leave the feedstock 34 in the reservoir and our dispersed into the electrolyte solution, they are then pumped with the electrolyte solution 38 into the vessel 40 and flow over the non-sacrificial anode 150 to contact the build plate 36.

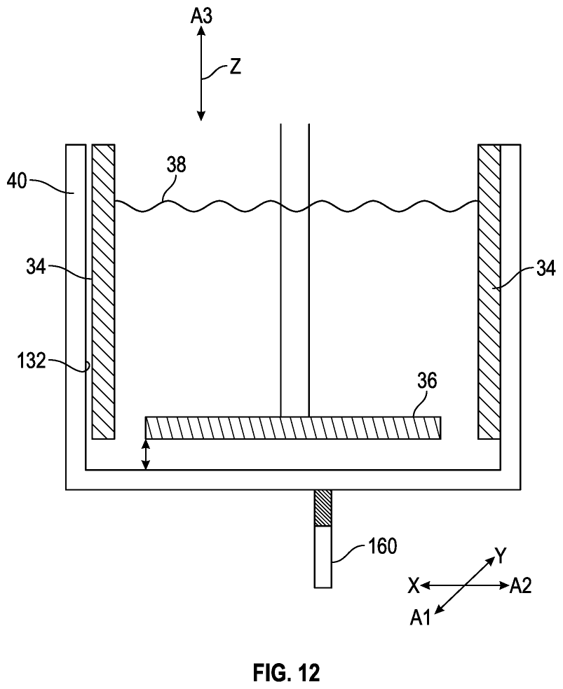

FIG. 12 illustrates in further aspect in which the feedstock 34 is provided in the electrolyte solution 38 at the vessel walls 132 in the vessel 40. A build plate 36 is attached to the first gantry 28, which moves the build plate 36 in the third axis A3. A radiative energy emitting source 160 that emits electromagnetic waves exhibiting one or more wavelengths in the visible and infrared range, such as, e.g., a laser or LED, is provided beneath the vessel 40, which is made from optically transparent glass or other material that, in aspects, exhibits less than five percent diffraction of light incident to the vessel 40. The radiative energy emitting source 160 is moved in the first axis A1 and second axis A2 to form traces 32 of the feedstock 34 on the build plate 36. The radiative energy emitting source 160 allows for spatially selective deposition, which may be understood as deposition in discrete locations across the surface of the build plate 36.

In any of the above aspects, the feedstock 34 is heated. A resistive heater or a radiative, electromagnetic source 160 may be used to heat the feedstock 34. Alternatively, or additionally, the radiative energy emitting source 160 may be used to heat the build plate 36 or traces 32. Or the build plate 36 and deposited traces 32 may be heated by a resistive heater provided within the build plate 36. Further, the electrolyte solution 38 is heated, in aspects, using a heater placed in the electrolyte solution 38. In one of aspect, the radiative, electromagnet source 160 heats up local areas and directs the deposition mostly to these areas to achieve the spatial selectivity. For example, the deposition tube may follow a laser trace; where the laser trace heats up a tiny area and provide enhanced deposition speed when deposition tubes enter this area.

Turning now to the deposition tubes 20, the deposition tube 20 is understood to limit the spread of E-fields between the feedstock 34, or non-sacrificial anode 150, and the build plate 36. Specifically, the spread of the E-field 76 is affected by one or more of the following characteristics: the inner diameter of the deposition tube 20, the thickness of the deposition tube 20, the height of the gap 66 between the deposition tube 20 and build plate 36, the distance the feedstock 34 from the exit 70 of the tube 20 and the material from which the deposition tube 20 is formed.

In various aspects, the deposition tubes 20 are formed from a conductive, semi-conductive, or nonconductive material as alluded to above. In aspects, deposition tubes 20 of conductive material may be held at the same potential as a feedstock 34. Deposition tubes 20 formed of conductive material may require lower energy consumption than non-conductive deposition tubes 20, may reduce runaway issues, and may provide a greater ability to manipulate the E-field over nonconductive deposition tubes 20. On the other hand, deposition tubes 20 formed from conductive material could introduce unwanted E-fields and atoms into the electrolyte solution 38. In aspects, conductive materials include materials that are relatively non-sacrificial in the electrolyte solution 38, such as graphite. Deposition tubes 20 formed of nonconductive materials, such as glass, and may control E-fields more easily and may provide a relatively simpler process as the tubes are non-sacrificial. However, nonconductive tubes 20 may require higher power input to the feedstock 34. Regardless of whether the deposition tubes 20 are conductive, semi-conductive or non-conductive, the deposition tube 20 should be non-corrosive in the electrolyte solution and resistant to water, acid, or bases, depending on the composition of the electrolyte solution 38.

In further aspects, the deposition tubes 20 may include coatings. For example, a deposition tube is formed from a non-conductive material and a conductive coating is applied to the deposition tube 20. In other examples, a deposition tube 20 is formed from a conductive material and a nonconductive coating is applied to the deposition tube 20. Coatings may allow for the selection and combination of desirable properties of the deposition tube 20.

It should be appreciated that many of the features described in the aspects above may be employed inter-changeably between the various aspects described herein.

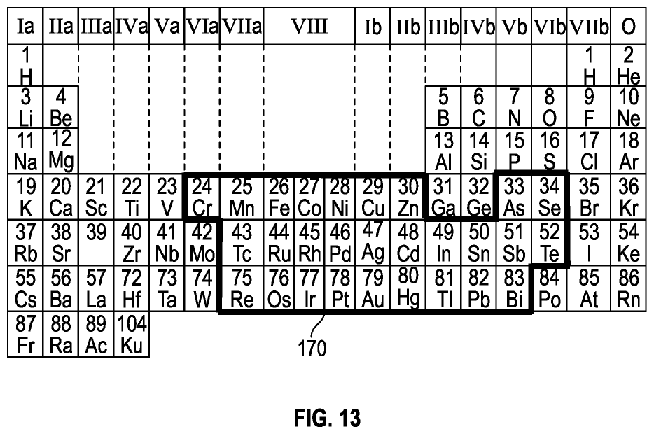

The feedstock 34, in aspects, is formed from a wire having a diameter of 10 microns to 10 millimeters, including all values and ranges therein. The feedstock 34 is formed from, for example, a material selected from the group of materials highlighted in box 170 of the periodic table provided in FIG. 13, including non-ferrous metals (copper, nickel), ferrous metals (iron), nickel-alloys, gold, silver, lead-free solder, chromium, lead alloys, tin-lead alloys, tin, zinc and zinc alloys, aluminum, palladium. It is also contemplated that steel may be deposited using the methods herein as well as titanium and refractory metals such as tungsten. It should be appreciated that while single metals are deposited in various aspects, in other aspects, alloys may also be deposited including binary alloys and ternary alloys.

The build plate 36 and electrolyte solution 38 are then chosen based upon the feedstock 34 selected. Table 1 below provides a list of metals and metal ions, wherein the ions listed can be electroplated on any metal build plate 36 below it in the table.

TABLE 1

| Metal/Metal | | Standard |
|---|---|---|
| Ion Couple | Electrode Reaction | Value (V) |
| Au/Au⁺ | Au⁺ + e ⇔ Au | 1.692 |
| Au/Au³⁺ | Au³⁺ + 3e ⇔ Au | 1.498 |
| Pd/Pd²⁺ | Pd²⁺ + 2e ⇔ Pd | 0.951 |
| Cu/Cu⁺ | Cu⁺ + e ⇔ Cu | 0.521 |
| Cu/Cu²⁺ | Cu²⁺ + 2e ⇔ Cu | 0.3419 |
| Fe/Fe³⁺ | Fe³⁺ + 3e ⇔ Fe | −0.037 |
| Pb/Pb²⁺ | Pb²⁺ + 2e ⇔ Pb | −0.1262 |
| Ni/Ni²⁺ | Ni²⁺ + 2e ⇔ Ni | −0.257 |
| Co/Co²⁺ | Co²⁺ + 2e ⇔ Co | −0.28 |
| Fe/Fe²⁺ | Fe¹⁺ + 2e ⇔ Fe | −0.447 |
| Zn/Zn²⁺ | Zn²⁺ + 2e ⇔ Zn | −0.7618 |
| Al/Al³⁺ | Al³⁺ + 3e ⇔ Al | −1.662 |
| Na/Na⁺ | Na⁺ + e ⇔ Na | −2.71 |

Source: G. Millazzo and S. Caroli, Tables of Standard Electrode Potentials, Wiley, New York, 1978.

The electrolyte solution 38 includes, for example, various aqueous solutions in addition to non-aqueous solutions. Further, molten salts, ionic liquids and organic salts may also be used.

In aspects, the feedstock 34, or non-sacrificial deposition anode 150, is vibrated at a relatively high frequency of 100 vibrations per second or greater, using in mechanical or electromechanical device such as a piezo actuator. Vibration of the feedstock 34, or non-sacrificial deposition anode 150, reduces irregularities in the build-up of the traces 32 on the build plate 36. In additional or alternative aspects, the build plate 36 is vibrated at similar rates.

As noted above, the electrolyte solution 38 is selected based on the deposition material forming the sacrificial anode 34, 100. Table 2 provide a list of solution type, operating temperature range for each type of solutions, current density that may be achieved with each solution and the benefits and drawbacks of each electrolyte solution 38.

TABLE 2

| | Temperature | Current density | | |
|---|---|---|---|---|
| Type | range (C.) | possible (A/dm²) | Why | Why not |
| Acidic | 20-45 | 1-30 | Speed, ease | Not uniform |
| Neutral | 40-70 | 3-10 | Uniformity and | Not stable, hard |
| | | | safety | composition, not |
| | | | | scalable |
| Basic (cyanide) | 20-30 | 1-5 | Uniformity | Slow, safety |
| Basic (non- | 18-35 | 0.5-6 | Uniformity | Slow, not stable |
| cyanide) | | | | |

Other factors include the following: levelling power of a solution, which is dependent on the coating thickness; brightening agents, dependent on temperature, current density, and critical concentrations; covering power as determined using hull cell, gives processing window; macrothrowing power provides uniformity and determined by hull cell or haring-Blum cell; and microthrowing power (inversely proportional to macro) determines extent of deposit on outer plane or cracks.

Further, the viscosity of the electrolyte solution 38 may be adjusted to increase, particularly as the print progresses, to provide a support for the three-dimensional object being printed as well as to reduce ion travel past the trace layer being deposited.

Turning now to the power supply, the power supply 48 may include either a DC or AC supply. In aspects, the waveforms may be chopped, and various duties/polarities/shapes may be employed. Further, as noted herein, the applied power can be switched to negative to ‘scrub’ areas for process advantages. Further, it is contemplated that an array of voltages may be applied in spatially distinct areas of the build plate 36 to tune E-fields. In addition, it is also contemplated that multiple feedstock 34 materials may be used and multiple diameter feedstock 34, or non-sacrificial anodes 150, may be used in a single process. Further, the deposition anodes (either feedstock 34 or non-sacrificial anodes) may be positioned multiple heights from the build plate 36.

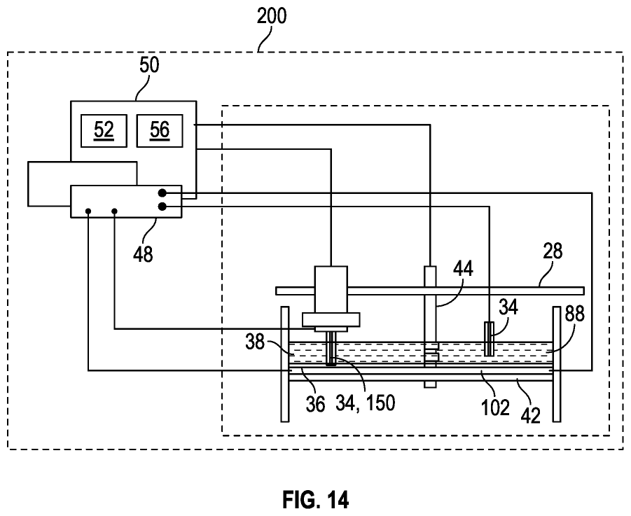

FIG. 14 illustrates a system 200 for printing a 3-dimensional component using electrodeposition. The system 200 includes a 3D printing apparatus with an XYZ motion control system provided by one or both of a first gantry 28 and a second gantry 44 for moving at least one of the deposition anode 34, 150 and the build plate 36 relative to the other at the deposition anode 34, 150 and the build plate 36. the system 200 further includes and electrolyte solution 38 in which the deposition anode 34, 150 may be immersed, or may simply contact both the deposition anode 34, 150 and the build plate 36. A reservoir 88 may also be provided for refreshing the electrolytes in the electrolyte solution 38. In addition, in aspects, a secondary anode including a feedstock 34 and a secondary cathode 102 is provided in the reservoir 88. The deposition anode 34, 150, the build plate 36, the secondary feedstock electrode 34 (if present), and the secondary cathode 102 (if present) are all individually coupled to a power supply 48. A controller 50, as described herein, executes instructions for performing the methods of electrodepositing a three dimensional object described herein.

In aspects, the controller 50 includes instructions for creating g-code to run the printer 10 for electrodepositing. The controller 50 may slice a CAD file, and the representation of the 3D object represented by the CAD file, into a number of layers representing each trace 32 to be sequentially deposited. Each layer is then broken up into a series of commands for moving one or both of the print head 26 including the deposition anode 34, 150 and the build plate 36 relative to the other as well as to provide instructions for the power to be supplied to the deposition anode 34, 150 and build plate 36.

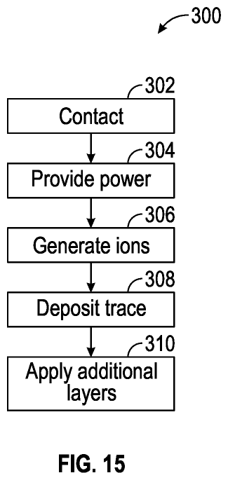

An aspect of a method 300 for 3D printing by electrodeposition is illustrated in FIG. 15. The method 300 begins with Contacting a feedstock 34 and a build plate 36 with an electrolyte solution 38 at block 302. At block 304 power is provided to the feedstock 34 and the built plate 36 creating a differential between the feedstock 34 and the build plate 36 creating a series of E fields 76 between the feedstock 34 and built plate 36. In aspects, the deposition anode 34, 150 is grounded and a voltage, a negative voltage, is provided to the build plate 36. At block 306, ions the feedstock 34 are generated. At block 308, the ions are transported by way of the E fields from the feedstock 34 to the build plate 36 and our deposited as a trace 32 on the build plate 36. Optionally, at block 310, additional layers traces 32 are applied sequentially over previously deposited layers.

The process may be controlled by controlling various characteristics and process parameters. Control of the characteristics of the electrolyte solution 38 is understood to assist in controlling the transport phenomena and the electrodeposition rates. These characteristics include one or more of the following: electrolyte solution 38 composition, temperature, and agitation. These characteristics may be adjusted during the process to alter the characteristics of the traces 32 being deposited. Controlling these characteristics affects the kinetic control of mass transport of ions from bulk to near the nernst layer. A nernst layer is understood to refer to a hypothetical scientific area on a concentration profile graph of an electrode and represents the hypothetical thickness of the diffusion layer that is present on an electrode immersed in an electrolytic solution. Controlling these characteristics also effects the kinetic control of diffusion of ions from bulk into the nernst layer. Diffusion of ions from bulk is also affected by rate of deposition. Further, kinetic control of mass transport within the nernst layer is affected by local thermal gradients or local agitation. Control of the reduction of the ions at the build plate 36 is affected by the voltage difference between the feedstock 34, or non-sacrificial anode 150, and the build plate 36. In addition, localized heating induces metal deposition, and, in aspects, the rate of deposition maybe increased by up to three orders of magnitude by heating the deposition surface.

Local heat inside the nernst layer drives the reaction forward by improving mass transport and thus the limiting diffusion is increased. If the heat is dispersed beyond Nernst layer, the benefits may not be present. Selectively irradiating some areas may drive more deposition compared to other areas on the surface. And, by locally heating within the nernst layer, up to 10 microns per second thickness is possible by sequentially depositing traces 32 over each other.

Furthermore, control of deposition current will affect the deposition rates and E-fields. This includes adjusting power pulses including pulse duration, polarity, height, over pulses, etc. Further, the deposition process may be reversed, and etching may be encouraged by switching the polarity of the current applied to the feedstock 34, or sacrificial anode 150, and the build plate 36. Etching may be used to shape and smooth the deposited traces 32. Etching will also be used to enhance the part density and reduce porosity and provide kinetic time for mobility of ions to set in proper lattice spaces. The pulse techniques will also be used to affect the grain structure change. As power, time to re arrange, speed of deposition and area of deposition and frequency of deposition will affect the grain structure.

E-fields are also understood to be affected by the temperature of the build plate 36, the electrolyte solution 38 temperature, the pH, ratio of current density to over potential, electrolyte solution 38 composition, and agitation.

### EXAMPLES

The examples presented herein stop for illustration purposes only and are not meant to be limiting of the subject matter disclosed herein.

### Example 1

An electrolyte solution of copper sulfate 226 grams, distilled water (0.5 L), and IM Sulfuric acid (0.5 L) was prepared. A ground lead was attached to an aluminum extrusion used as a base plate cathode. A positive voltage lead was attached to a copper rod used as a sacrificial, deposition anode. A couple of drops of the electrolyte solution 38 were added onto the aluminum extrusion build plate 36 and the solution was given some time to let settle out to form a thin layer deposited on the aluminum surface.

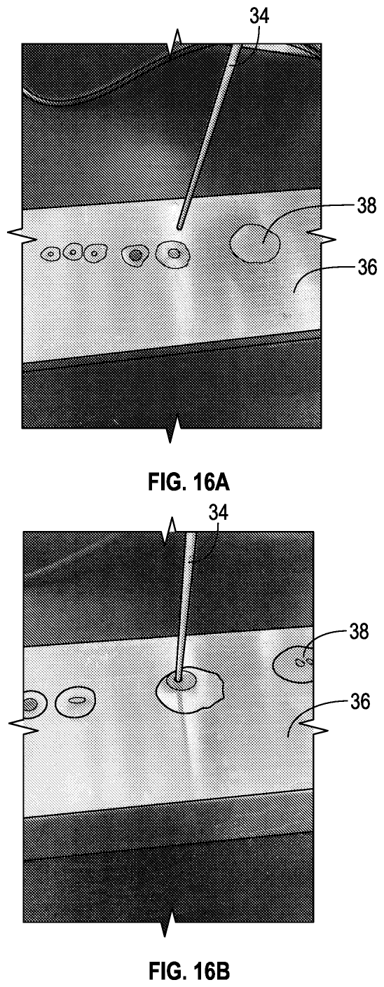

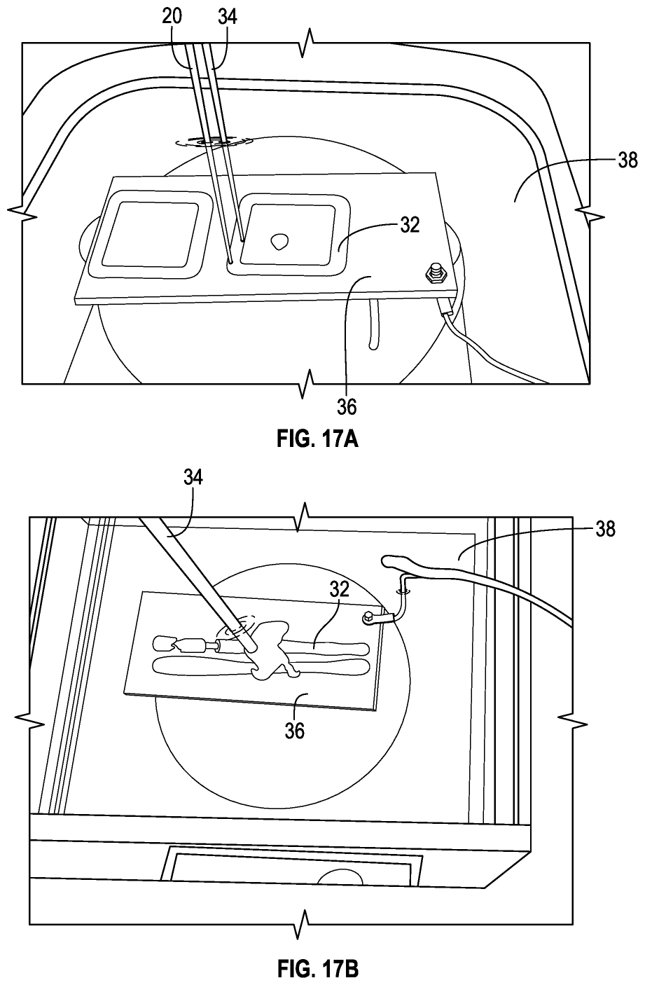

The power supply was turned on and several voltage/current limits, up to 30V 3 A, were applied to the leads. The copper rod was provided as feedstock 34 and slowly lowered to just sit inside the thin film of the electrolyte solution on the aluminum extrusion and copper was deposited onto the aluminum. Care was taken not to touch the rod to the extrusion, as this would short the power supply. At higher voltage/current settings, near immediate reaction of the electrolyte solution turning into copper was observed. At relatively slower settings, a relatively more controlled reaction rate, more copper color in nature, was observed. After processing, the copper could be removed from the aluminum extrusion. FIGS. 16A and B illustrate the resultant copper from the feedstock 34 in the electrolyte solution 38 deposited on the aluminum extrusion build plate 36.

### Example 2

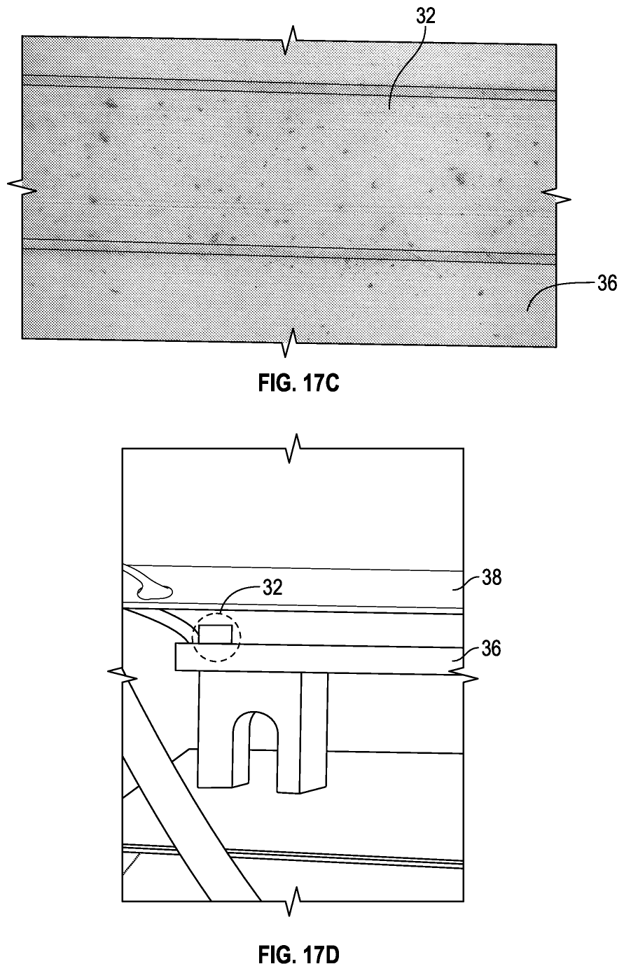

A copper wire feedstock 34 was used as a deposition anode and affixed to a print head of a three-dimensional printer and an aluminum extrusion, used as a cathode, was placed in a vessel containing the electrolyte solution 38 of copper sulfate 160 grams, distilled water (1.75 L), 150 mg of copper chloride and pure Sulfuric acid (0.25 L). The power supply 48 was turned on and several voltage/current limits, up to 30V 3 A, were applied to the leads. Various shapes of traces 32 were formed on an aluminum extrusion 36 in the electrolyte solution 38 by translating the copper wire feedstock 34 with the print head 26 as seen in FIGS. 17A and 17B. In FIG. 17A, the copper wire feedstock 34 is provided in a glass deposition tube 20. 17C is a close-up showing a trace 32 having a thickness of approximately 1 mm. Further, as illustrate in FIG. 17D, a pillar 18 was built by maintaining the location of the copper wire 34 and altering the location of the aluminum extrusion build plate 36 relative to the copper wire 34.

The three-dimensional components produced by the systems, methods, and printers described herein may be utilized in a number of fields including one or more of the following: exchangers, telecommunications, circuit components for radio frequency systems, radar components, engine components for aerospace, noncorrosive coatings for corrosive metals, automotive peripherals, transmission systems, gears and gearboxes, medical implants, jewelry, semiconductor industry, custom brackets, custom tools, heating, custom robot arm ends, low volume end use parts, etc.

The machine, process, and materials described herein present a number of advantages. Such advantages include an additive manufacturing platform which allows the user to create relatively complex geometries at sub-micron resolution in metal, including high purity metals of 99.99% purity. Such advantages also include spatial control of the deposition, achieving relatively high build rates, deposition in multiple axis while achieving definition, overcoming various transport phenomena involved to achieve consistent build rate, and changing electric field lines due to change dissolution of anode to provide relatively more consistent traces.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A three-dimensional printer for electrodeposition, comprising:
a deposition anode, wherein the deposition anode is a feedstock;
a build plate immersed in an electrolyte solution, wherein at least one of the deposition anode and build plate are moveable relative to the other in at least two axes;
a mounting tray;
a vessel positioned on the mounting tray, wherein the vessel contains the build plate;
a print head including a wire feed for feeding the feedstock, the print head movable in a first axis and a second axis and the mounting tray moveable in a third axis; and
a power supply electrically connected to the deposition anode and the build plate.

2-4. (canceled)

5. The three-dimensional printer of claim 1, further comprising a deposition tube included in the print head through which the feedstock passes.

6. The three-dimensional printer of claim 5, wherein the deposition tube and the build plate are separated by a gap.

7. The three-dimensional printer of claim 5, wherein the deposition tube is conductive.

8. The three-dimensional printer of claim 5, further comprising a seal between the deposition tube and the feedstock.

9. The three-dimensional printer of claim 8, further comprising a reservoir connected to the deposition tube.

10. The three-dimensional printer of claim 5, further comprising a conductive ring at the base of the deposition tube.

11. The three-dimensional printer of claim 10, further comprising an insulator positioned between the conductive ring and the deposition tube.

12. The three-dimensional printer of claim 5, further comprising a sensor mounted to the deposition tube, configured to obtain data regarding one or more of the following: the height of the feedstock within the deposition tube, the height of the deposition tube relative to the build plate, and detection of a characteristic of the feedstock.

13. The three-dimensional printer of claim 1, further comprising a reservoir connected to the vessel by an inlet flow path and an outlet flow path.

14. The three-dimensional printer of claim 13, further comprising a pump connected to the outlet flow path.

15. The three-dimensional printer of claim 13, further comprising a heater immersed in the reservoir.

16. The three-dimensional printer of claim 13, wherein the deposition anode is non-sacrificial.

17. The three-dimensional printer of claim 16, further comprising a secondary anode positioned in the reservoir and a secondary cathode positioned in the reservoir, wherein the secondary anode provides a feedstock.

18. The three-dimensional printer of claim 1, further comprising a magnetic stirrer positioned beneath the build plate.

19-20. (canceled)
